(19) United States
(12) Patent Application Publication
(10) Pub. No.: US 2020/0096351 A1
(43) Pub. Date: Mar. 26, 2020

(54) MEETING SUPPORT DEVICE AND MEETING SUPPORT METHOD

(71) Applicant: TOYOTA JIDOSHA KABUSHIKI KAISHA, Toyota-shi (JP)

(72) Inventor: Naoto SASAGAWA, Nishio-shi (JP)

(73) Assignee: TOYOTA JIDOSHA KABUSHIKI KAISHA, Toyota-shi (JP)

(21) Appl. No.: 16/536,473

(22) Filed: Aug. 9, 2019

(30) Foreign Application Priority Data
Sep. 21, 2018 (JP) 2018-177390

(51) Int. Cl. G01C 21/34; G09B 29/10

(52) U.S. Cl. CPC G01C 21/3438; G09B 29/106

(57) ABSTRACT

A meeting management unit acquires information of each of a first user and a second user who are to meet up, a meeting time, and a meeting position. A position acquirer acquires position information of a first mobile terminal of the first user and position information of a second mobile terminal of the second user. When the position information of the first mobile terminal indicates that the first user has arrived at the meeting position earlier than the second user and moved away from the meeting position, a change proposing unit transmits, to the first mobile terminal, information for recommending changing the meeting position based on the position information of the first mobile terminal away from the meeting position.

### BACKGROUND

### 1. Technical Field

The present disclosure relates to a technology for supporting meeting up of users.

### 2. Description of Related Art

JP-A-2007-72588 discloses a meeting support device for helping a pedestrian and a driver on a vehicle to meet up at a meeting place. In the technology disclosed in JP-A-2007-72588, when the pedestrian and the driver are present within a predetermined range, their terminals are informed thereof, and, when one of them arrives at the meeting place, the terminal of the other is informed thereof.

[Patent Document 1] Japanese Unexamined Patent Application Publication No. 2007-72588 (JP-A-2007-72588)

In the technology disclosed in JP-A-2007-72588, however, when a person arrives at the meeting place early and leaves there to fill the time until the meeting time, the person needs to come back to the place by the meeting time. Also, to change the meeting place, the person needs to make contact with the other person via the phone or e-mail, causing bothersome chores for each other.

### SUMMARY

A general purpose of the present disclosure is to provide a technology for smoothly changing the meeting position.

In response to the above issue, a meeting support device of one embodiment of the present disclosure includes: a meeting management unit configured to acquire information of each of a first user and a second user who are to meet up, a meeting time, and a meeting position; a position acquirer configured to acquire position information of a first mobile terminal of the first user and position information of a second mobile terminal of the second user; and a change proposing unit configured to transmit, when the position information of the first mobile terminal indicates that the first user has arrived at the meeting position earlier than the second user and moved away from the meeting position, information for recommending changing the meeting position on the basis of the position information of the first mobile terminal away from the meeting position, to the first mobile terminal.

Another embodiment of the present disclosure relates to a meeting support method. The meeting support method includes: acquiring information of each of a first user and a second user who are to meet up, a meeting time, and a meeting position; acquiring position information of a first mobile terminal of the first user and position information of a second mobile terminal of the second user; and transmitting, when the position information of the first mobile terminal indicates that the first user has arrived at the meeting position earlier than the second user and moved away from the meeting position, information for recommending changing the meeting position on the basis of the position information of the first mobile terminal away from the meeting position, to the first mobile terminal.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram that shows an overview of a meeting support system according to an embodiment;

FIG. 2 is a diagram used to describe a situation where a first user and a second user plan a meeting and join up.

FIG. 3 is a diagram used to describe a functional configuration of a meeting support device; and

FIG. 4 is a diagram used to describe a flowchart for changing a meeting position.

### DETAILED DESCRIPTION

An embodiment will now be described. The embodiment is illustrative and is not intended to be limiting.

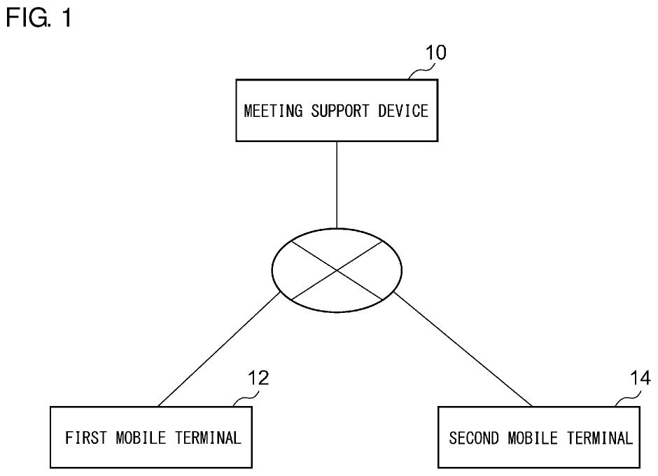

FIG. 1 shows an overview of a meeting support system 1 according to an embodiment. The meeting support system 1 supports meeting up of a first user who has a first mobile terminal 12 and a second user who has a second mobile terminal 14.

One of the first mobile terminal 12 and the second mobile terminal 14 transmits meeting information of a first user 16 and a second user 18, to a meeting support device 10. The meeting information includes a departure point of each user, a departure time of each user, a meeting position, a meeting time, transportation of each user, and information of each user. The information of the first user 16 and the second user 18 may be the respective user IDs, for example, and the user ID of the first user 16 is related to a terminal ID of the first mobile terminal 12, and the user ID of the second user 18 is related to a terminal ID of the second mobile terminal 14. Each of the first mobile terminal 12 and the second mobile terminal 14 transmits position information to the meeting support device 10 with a predetermined period.

The meeting support device 10 supports meeting up of the first user 16 and the second user 18, using the meeting information and the position information of each of the first mobile terminal 12 and the second mobile terminal 14.

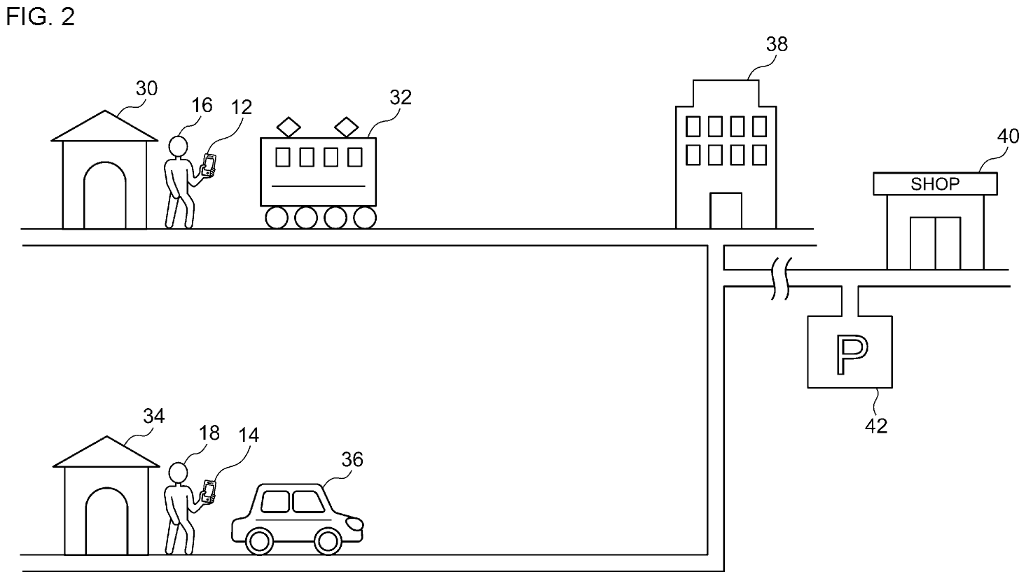

FIG. 2 is a diagram used to describe a situation where the first user 16 and the second user 18 plan a meeting and join up. The first user 16 and the second user 18 plan to meet up at a meeting position 38, and the first user 16 plans to travel from a first departure point 30 to the meeting position 38 using a train 32, and the second user 18 plans to travel from a second departure point 34 to the meeting position 38 using an automobile 36. The first mobile terminal 12 or the second mobile terminal 14 transmits the meeting information to the meeting support device 10.

The meeting support device 10 follows the position information of each of the first mobile terminal 12 and the second mobile terminal 14 and monitors if the first user 16 and the second user 18 arrive at the meeting position 38. It is assumed here that the first user 16 has arrived at the meeting position 38 earlier than the second user 18, and the first user 16 has left the meeting position 38 and moved to a shop 40 to fill the time until the second user 18 arrives.

Based on the position information of the first mobile terminal 12, the meeting support device 10 detects the situation where the first user 16 has arrived at the meeting position 38 and then moved away from the meeting position 38, and the meeting support device 10 then proposes, to the first user 16 via the first mobile terminal 12, changing the meeting position to a parking area 42 near the shop 40. If the first user 16 accepts the proposal, the meeting support device 10 will then propose, to the second user 18 via the second mobile terminal 14, the change of the meeting position. If the second user 18 also accepts the proposal, the meeting support device 10 will allow the first mobile terminal 12 and the second mobile terminal 14 to convey the change of the meeting position to the parking area 42. Accordingly, only with the acceptance by the first user 16 and the second user 18, the meeting position can be smoothly changed.

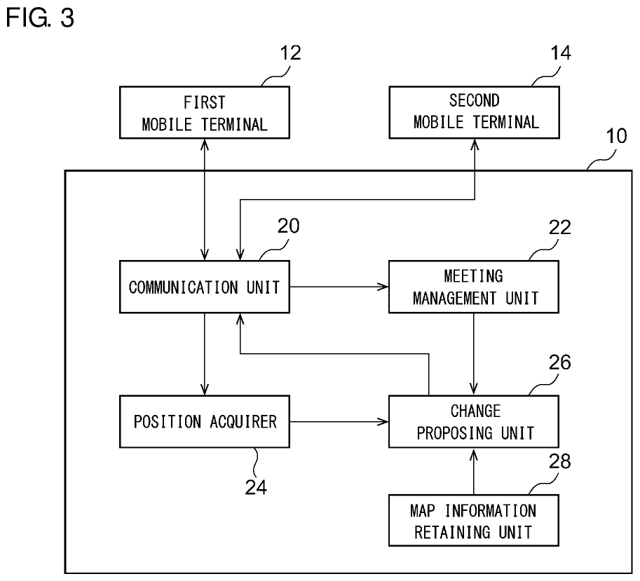

FIG. 3 is a diagram used to describe a functional configuration of the meeting support device 10. Each of the elements represented by functional blocks for performing various processes shown in FIG. 3 can be implemented by a circuit block, a memory, an LSI or the like in terms of hardware, and by a program loaded into a memory or the like in terms of software. Accordingly, it will be obvious to those skilled in the art that these functional blocks may be implemented in a variety of forms by hardware only, software only, or a combination thereof, and the form is not limited to any of them.

The meeting support device 10 includes a communication unit 20, a meeting management unit 22, a position acquirer 24, a change proposing unit 26, and a map information retaining unit 28. The communication unit 20 communicates with the first mobile terminal 12 and the second mobile terminal 14.

The meeting management unit 22 acquires meeting information from the first mobile terminal 12 and the second mobile terminal 14 via the communication unit 20. The meeting information at least includes a meeting position, a meeting time, and the ID of each user, and may further include the transportation of each user, the departure point of each user, and the departure time of each user. The meeting management unit 22 retains the user IDs of the first user 16 and the second user 18 respectively related to the terminal IDs of the first mobile terminal 12 and the second mobile terminal 14. Alternatively, the first mobile terminal 12 and the second mobile terminal 14 may transmit the meeting information to another server device, and the meeting management unit 22 may acquire the meeting information from the another server device.

The position acquirer 24 acquires, from each of the first mobile terminal 12 and the second mobile terminal 14, the position information thereof with a predetermined period. Accordingly, the positions of the first user 16 and the second user 18 can be tracked.

The map information retaining unit 28 retains map information. The map information includes position information of a place suitable for a meeting position, and also includes information of a place where an automobile can be stopped. The place where an automobile can be stopped is not limited to a parking area, and may be a place where vehicles are frequently stopped, such as a rotary between stations, extracted based on gathered pieces of traveling information of multiple vehicles.

When the position information of the first mobile terminal 12 indicates that the first user 16 has arrived at the meeting position earlier than the second user 18 and moved away from the meeting position, the change proposing unit 26 transmits, to the first mobile terminal 12, information for recommending changing the meeting position based on the position information of the first mobile terminal 12 away from the meeting position. If the first user 16 accepts the change of the meeting position conveyed to the first mobile terminal 12, proceeding for changing the meeting position can be advanced. Thus, changing a meeting position is proposed when a user has moved away from the meeting position, enabling a change of the meeting position consistent with an intention of the user away from the meeting position. Also, even though the first user 16 does not directly propose changing the meeting position to the second user 18, the meeting position can be smoothly changed.

A changed meeting position is set to a position to which the first user 16 is closer than to the original meeting position. In other words, the distance between the position indicated by the position information of the first mobile terminal 12 and the changed meeting position is shorter than the distance between the position indicated by the position information of the first mobile terminal 12 and the original meeting position. When the position information of the first mobile terminal 12 is unchanged for a few minutes or more at a position apart from the meeting position by a predetermined distance or more, the change proposing unit 26 may derive a changed meeting position based on the unchanged position. While no user arrives at the meeting position, the change proposing unit 26 need not propose changing the meeting position.

Based on the position information of the first mobile terminal 12, when it is found that the first user 16 has once arrived at the meeting position and then moved away from the meeting position by a predetermined distance or more, the change proposing unit 26 determines to propose changing the meeting position. The change proposing unit 26 allows the first mobile terminal 12 and the second mobile terminal 14 to convey a query as to whether or not to accept the change of the meeting position, providing options. For example, a question of “Will you change the meeting position to the parking area 42?” and a button for an option of “Yes” or “No” may be displayed on the display of the first mobile terminal 12. Accordingly, the user only needs to perform an operation for selecting an option and hence can easily answer the query as to whether or not to accept the proposal of the change even when the user is driving. Therefore, changing the meeting position can be smoothly advanced.

If the change proposing unit 26 receives, from the first mobile terminal 12, information indicating acceptance of the change of the meeting position and if the change proposing unit 26 then also receives, from the second mobile terminal 14, information indicating acceptance of the change of the meeting position, the change proposing unit 26 will determine the change of the meeting position. Thus, by first checking with a user who has moved away from a meeting position as to a change of the meeting position, the intention of the user who has arrived earlier can be checked before the change is advanced, and, by confirming thereafter whether or not another user accepts the change, the change can be smoothly advanced without any user's complaint.

When proposing changing the meeting position, the change proposing unit 26 proposes a position suitable for meeting up based on the transportation of each of the first user 16 and the second user 18. Since the change proposing unit 26 determines and proposes a changed meeting position, changing the meeting position can be smoothly advanced. Also, since a position suitable for meeting up is determined based on the transportation, even when a user drives a vehicle as shown in FIG. 2, a position where a vehicle can be easily stopped can be proposed, thereby facilitating the meeting up. Thus, since the process for changing a meeting position can be simplified, this system is particularly useful when the transportation of the users who are to meet up includes by car.

When the change proposing unit 26 has determined the change of the meeting position, the change proposing unit 26 changes the destination in the navigation program on the second mobile terminal 14 to the changed meeting position. Accordingly, the second user 18 during traveling need not perform the operation for setting the destination to the meeting position and can smoothly travel to the changed meeting position even during driving. Also, the destination in the navigation program on the first mobile terminal 12 may be changed to the changed meeting position.

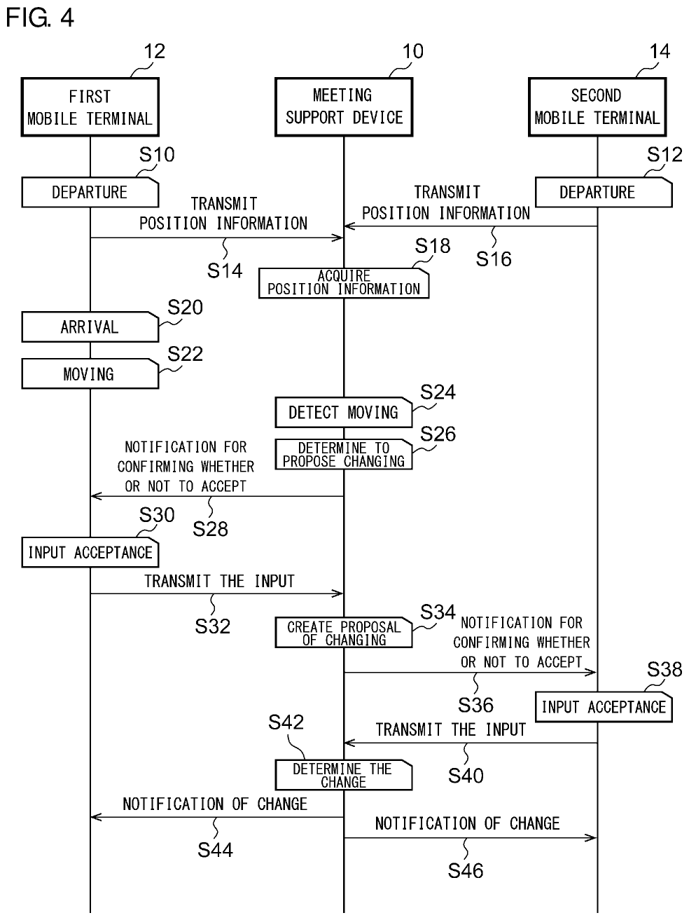

FIG. 4 is a diagram used to describe a flowchart for changing a meeting position. In the description for FIG. 4, FIG. 2 is also used. The meeting support device 10 retains meeting information of the first user 16 who has the first mobile terminal 12 and the second user 18 who has the second mobile terminal 14.

The first user 16 departs for the meeting position 38 carrying the first mobile terminal 12 (S10), and the second user 18 also departs for the meeting position 38 carrying the second mobile terminal 14 (S12). The first mobile terminal 12 transmits the position information of the first mobile terminal 12 to the meeting support device 10 (S14), and the second mobile terminal 14 transmits the position information of the second mobile terminal 14 to the meeting support device 10 (S16).

Based on the position information of each of the first mobile terminal 12 and the second mobile terminal 14, the meeting support device 10 tracks the first user 16 and the second user 18 from the respective departure times (S18). The first user 16 arrives at the meeting position 38 earlier than the second user 18 (S20) and, since the first user 16 has time to spare before the meeting time, the first user 16 leaves the meeting position 38 to move to the shop 40 (S22).

Based on the position information of the first mobile terminal 12, the change proposing unit 26 of the meeting support device 10 detects the situation where the first user 16 has moved from the meeting position 38 to the shop 40 and stays there (S24), and, since the first user 16 has moved away from the meeting position 38 by a predetermined distance or more, the change proposing unit 26 determines to propose changing the meeting position (S26). Accordingly, the change proposing unit 26 transmits, to the first mobile terminal 12, a query as to whether or not to accept the change of the meeting position, providing options (S28).

The first user 16 performs an input operation for acceptance with regard to the query with options displayed on the first mobile terminal 12 (S30), and the first mobile terminal 12 transmits the input result indicating the acceptance to the meeting support device 10 (S32).

The change proposing unit 26 of the meeting support device 10 receives the input result indicating the acceptance from the first mobile terminal 12 to advance the change of the meeting position, and creates a proposal of changing the meeting position to the parking area 42, based on the position information of the first mobile terminal 12 and the transportation of the second user 18 (S34). The change proposing unit 26 then transmits, to the second mobile terminal 14, a query as to whether or not to accept the change of the meeting position, providing options (S36).

The second user 18 performs an input operation for acceptance with regard to the query with options displayed on the second mobile terminal 14 (S38), and the second mobile terminal 14 transmits the input result indicating the acceptance to the meeting support device 10 (S40).

Upon checking with the first user 16 and the second user 18, the change proposing unit 26 determines the change of the meeting position to the parking area 42; accordingly, the change proposing unit 26 notifies the first mobile terminal 12 of the fact that the meeting position has been changed to the parking area 42 (S44), and also notifies the second mobile terminal 14 thereof (S46).

The embodiment is intended to be illustrative only, and it will be obvious to those skilled in the art that various modifications to a combination of constituting elements could be developed and that such modifications also fall within the scope of the present embodiment.

Although the embodiment describes a situation in which the first user 16 and the second user 18 are to meet up, the number of persons is not limited to two, and three or more persons may meet up using the meeting support system 1. The case of three or more persons can also be described using the aforementioned embodiment, considering that there are multiple second users who arrive later, besides the first user who arrives first.

Also, although the embodiment describes a mode in which the meeting support device 10 proposes a change of a meeting position to the first user 16 who has arrived earlier, and then proposes the change of the meeting position to the second user 18 who arrives later, the mode is not limited thereto. The meeting support device 10 may propose a change of a meeting position to mobile terminals of all users at a time, and, upon reception of acceptance from all the users, the meeting support device 10 may determine the change of the meeting position.

The second mobile terminal 14 in the embodiment may be a vehicle-mounted terminal on the automobile 36.

1. A meeting support device, comprising:
a meeting management unit configured to acquire information of each of a first user and a second user who are to meet up, a meeting time, and a meeting position;
a position acquirer configured to acquire position information of a first mobile terminal of the first user and position information of a second mobile terminal of the second user; and
a change proposing unit configured to transmit, when the position information of the first mobile terminal indicates that the first user has arrived at the meeting position earlier than the second user and moved away from the meeting position, information for recommending changing the meeting position on the basis of the position information of the first mobile terminal away from the meeting position, to the first mobile terminal.

2. The meeting support device of claim 1, wherein the change proposing unit allows the first mobile terminal to convey a query as to whether or not to accept a change of a meeting position, providing options.

3. The meeting support device of claim 1, wherein, when the change proposing unit receives, from the first mobile terminal, information indicating acceptance of a change of a meeting position and when the change proposing unit then also receives, from the second mobile terminal, information indicating acceptance of the change of the meeting position, the change proposing unit determines the change of the meeting position.

4. The meeting support device of claim 1, wherein:
the meeting management unit acquires transportation of each of the first user and the second user; and,
when the change proposing unit proposes changing a meeting position, the change proposing unit proposes a position suitable for meeting up, on the basis of the transportation of each of the first user and the second user.

5. The meeting support device of claim 1, wherein, when the change proposing unit determines a change of a meeting position, the change proposing unit transmits, to the second mobile terminal, information for setting the destination in a navigation program on the second mobile terminal to the changed meeting position.

6. A meeting support method, comprising:
acquiring information of each of a first user and a second user who are to meet up, a meeting time, and a meeting position;
acquiring position information of a first mobile terminal of the first user and position information of a second mobile terminal of the second user; and transmitting, when the position information of the first mobile terminal indicates that the first user has arrived at the meeting position earlier than the second user and moved away from the meeting position, information for recommending changing the meeting position on the basis of the position information of the first mobile terminal away from the meeting position, to the first mobile terminal.

7. The meeting support device of claim 2, wherein, when the change proposing unit receives, from the first mobile terminal, information indicating acceptance of a change of a meeting position and when the change proposing unit then also receives, from the second mobile terminal, information indicating acceptance of the change of the meeting position, the change proposing unit determines the change of the meeting position.

8. The meeting support device of claim 2, wherein:
the meeting management unit acquires transportation of each of the first user and the second user; and,
when the change proposing unit proposes changing a meeting position, the change proposing unit proposes a position suitable for meeting up, on the basis of the transportation of each of the first user and the second user.

9. The meeting support device of claim 3, wherein:
the meeting management unit acquires transportation of each of the first user and the second user; and,
when the change proposing unit proposes changing a meeting position, the change proposing unit proposes a position suitable for meeting up, on the basis of the transportation of each of the first user and the second user.

10. The meeting support device of claim 7, wherein:
the meeting management unit acquires transportation of each of the first user and the second user; and,
when the change proposing unit proposes changing a meeting position, the change proposing unit proposes a position suitable for meeting up, on the basis of the transportation of each of the first user and the second user.

11. The meeting support device of claim 2, wherein, when the change proposing unit determines a change of a meeting position, the change proposing unit transmits, to the second mobile terminal, information for setting the destination in a navigation program on the second mobile terminal to the changed meeting position.

12. The meeting support device of claim 3, wherein, when the change proposing unit determines a change of a meeting position, the change proposing unit transmits, to the second mobile terminal, information for setting the destination in a navigation program on the second mobile terminal to the changed meeting position.

13. The meeting support device of claim 4, wherein, when the change proposing unit determines a change of a meeting position, the change proposing unit transmits, to the second mobile terminal, information for setting the destination in a navigation program on the second mobile terminal to the changed meeting position.

14. The meeting support device of claim 7, wherein, when the change proposing unit determines a change of a meeting position, the change proposing unit transmits, to the second mobile terminal, information for setting the destination in a navigation program on the second mobile terminal to the changed meeting position.

15. The meeting support device of claim 8, wherein, when the change proposing unit determines a change of a meeting position, the change proposing unit transmits, to the second mobile terminal, information for setting the destination in a navigation program on the second mobile terminal to the changed meeting position.

16. The meeting support device of claim 9, wherein, when the change proposing unit determines a change of a meeting position, the change proposing unit transmits, to the second mobile terminal, information for setting the destination in a navigation program on the second mobile terminal to the changed meeting position.

17. The meeting support device of claim 10, wherein, when the change proposing unit determines a change of a meeting position, the change proposing unit transmits, to the second mobile terminal, information for setting the destination in a navigation program on the second mobile terminal to the changed meeting position.
